(19) United States
(12) Patent Application Publication
(10) Pub. No.: US 2023/0129795 A1
(43) Pub. Date: Apr. 27, 2023

(54) MACHINE LEARNING METHOD, MACHINE LEARNING DEVICE, MACHINE LEARNING PROGRAM, COMMUNICATION METHOD, AND CONTROL DEVICE

(71) Applicant: KABUSHIKI KAISHA KOBE SEIKO SHO (KOBE STEEL, LTD.), Hyogo (JP)

(72) Inventors: Hiroyuki ITO, Takasago-shi (JP); Tomoya MINAMINO, Takasago-shi (JP); Hiroshi SHIRAKASHI, Takasago-shi (JP); Yoshikazu KISHI, Takasago-shi (JP); Tadataka MIZOKAMI, Takasago-shi (JP); Yasuhide MIYASHITA, Takasago-shi (JP)

(73) Assignee: KABUSHIKI KAISHA KOBE SEIKO SHO (KOBE STEEL, LTD.), Hyogo (JP)

(21) Appl. No.: 18/046,683

(22) Filed: Oct. 14, 2022

(30) Foreign Application Priority Data
Oct. 22, 2021 (JP) 2021-173017

(51) Int. Cl. B22F 3/04

(52) U.S. Cl. CPC B22F 3/04

(57) ABSTRACT

A machine learning method includes: calculating a reward for a result of decision of a cold isostatic pressing process condition based on an acquired state variable; updating, based on the reward, a function to decide at least one cold isostatic pressing process condition from the state variable; and deciding a cold isostatic pressing process condition which yields a highest reward, by repeating update of the function. The cold isostatic pressing process condition is at least one of a first parameter related to an object to be processed, a second parameter related to a preceding process of a cold isostatic pressing process, and a third parameter related to operating conditions of a cold isostatic pressing apparatus, and the at least one physical amount is related to at least one of sterilization and inactivation, shucking, improvement of taste and flavor, and improvement of texture and nourishment of the object to be processed.

### BACKGROUND OF THE INVENTION

### 1. Field of the Invention

The present invention relates to a machine learning technique to learn cold isostatic pressing conditions for a cold isostatic pressing apparatus.

### 2. Description of the Related Art

Cold isostatic pressing (CIP) apparatuses have been known (for example, Japanese Unexamined Patent Application Publication No. 2021-4692) which use a cold isostatic pressing (CIP) method to perform a pressure process on an object to be processed such as a food item for the purpose of sterilizing microorganisms adhering to the object to be processed. In such a pressing apparatus, a pressing process is performed by storing an object to be processed in a cylindrical pressure vessel, and enclosing a pressure medium in the pressure vessel. As compared to a heating process at a high temperature, such a pressure process is effective because the taste, texture and flavor of a food item are less likely to be sacrificed. In order to obtain high-quality CIP processed products, it is required that a CIP process condition such as a pressing condition be appropriately decided.

### SUMMARY OF THE INVENTION

However, CIP process conditions have been decided based on accumulated research data in the past, thus it has been difficult to readily decide an appropriate CIP process condition for an object to be processed.

It is an object of the disclosure to provide a machine learning method capable of efficiently deriving an appropriate CIP process condition for an object to be processed.

A machine learning method according to an aspect of the disclosure provides a machine learning method by which a machine learning device decides a cold isostatic pressing process condition for a cold isostatic pressing apparatus that performs a cold isostatic pressing process using a pressure medium for an object to be processed, the cold isostatic pressing apparatus including: a pressure vessel that stores the object to be processed, a compressor that supplies the pressure medium to the pressure vessel, a pressure adjustment mechanism configured to adjust a pressure in the pressure vessel, and a control device that controls the cold isostatic pressing apparatus, the machine learning method comprising: acquiring a state variable including at least one physical amount related to the object to be processed, and at least one cold isostatic pressing process condition; calculating a reward for a result of decision of the at least one cold isostatic pressing process condition based on the state variable; updating, based on the reward, a function to decide the at least one cold isostatic pressing process condition from the state variable while changing the at least one cold isostatic pressing process condition; and deciding a cold isostatic pressing process condition which yields a highest reward, by repeating update of the function, wherein the at least one cold isostatic pressing process condition is at least one of a first parameter related to the object to be processed, a second parameter related to a preceding process of the cold isostatic pressing process, and a third parameter related to operating conditions of the cold isostatic pressing apparatus, the at least one physical amount being at least one of a physical amount related to sterilization and inactivation, a physical amount related to shucking, a physical amount related to improvement of taste and flavor, and a physical amount related to improvement of texture and nourishment of the object to be processed.

According to the aspect, at least one of a first parameter related to an object to be processed, a second parameter related to a preceding process of a cold isostatic pressing process, and a third parameter related to operating conditions of a cold isostatic pressing apparatus is acquired as a state variable. In addition, at least one of a physical amount related to sterilization and inactivation, a physical amount related to shucking, a physical amount related to improvement of taste and flavor, and a physical amount related to improvement of texture and nourishment of an object to be processed is acquired as a state variable.

A reward for a result of decision of a cold isostatic pressing process condition is then calculated based on the acquired state variable, a function to decide a cold isostatic pressing process condition from the state variable is updated based on the calculated reward, and a cold isostatic pressing process condition which yields a highest reward is learned by repeating the update. Thus, a cold isostatic pressing process condition can be derived efficiently.

In the above-described machine learning method, the at least one cold isostatic pressing process condition may include the first parameter, and the first parameter may be at least one of an amount of processing, an arrangement, a shape, a dimension, with or without packaging, a true density, a component absorption property of a packaging material and a volume of a packaging material of the object to be processed.

According to this aspect, as the first parameter, at least one of an amount of processing, an arrangement, a shape, a dimension, with or without packaging, and a true density of the object to be processed is acquired as a state variable related to the object to be processed, and machine learning is performed, thus an appropriate cold isostatic pressing process condition can be decided in consideration of the state of the object to be processed.

In the above-described machine learning method, the at least one cold isostatic pressing process condition may include the second parameter, and the second parameter may be at least one of a preheat temperature, a preheat time, and a degree of vacuum for vacuum packaging.

According to this aspect, as the second parameter, at least one of a preheat temperature, a preheat time, and a degree of vacuum for vacuum packaging is acquired as a state variable related to a preceding process, and machine learning is performed, thus an appropriate cold isostatic pressing process condition can be decided in consideration of the state of the preceding process.

In the above-described machine learning method, the at least one cold isostatic pressing process condition may include the third parameter, and the third parameter may be at least one of a process pressure, a pressure increase rate, a pressure decrease rate, a pressure holding time, with or without stepwise pressure increase, and with or without stepwise pressure decrease in the cold isostatic pressing process.

According to this aspect, as the third parameter, at least one of a process pressure, a pressure increase rate, a pressure decrease rate, a pressure holding time, with or without stepwise pressure increase, and with or without stepwise pressure decrease in the cold isostatic pressing process is acquired as a state variable related to operating conditions, and machine learning is performed, thus an appropriate cold isostatic pressing process condition can be decided in consideration of the operating conditions.

In the above-described machine learning method, the cold isostatic pressing apparatus may further includes a temperature adjustment mechanism configured to adjust a temperature of a pressure medium in the pressure vessel, and the control device may be configured to further control the temperature adjustment mechanism. The third parameter may be at least one of a process pressure, a pressure increase rate, a pressure decrease rate, a pressure holding time, with or without stepwise pressure increase, with or without stepwise pressure decrease, a process temperature, a temperature increase rate during process, a temperature decrease rate during process, and a temperature distribution in the cold isostatic pressing process.

According to this aspect, the characteristic of the object to be processed can be favorably changed by adjusting the temperature in the pressure vessel with the temperature adjustment mechanism. When as the third parameter, at least one of a process temperature, a temperature increase rate during process, a temperature decrease rate during process, and a temperature distribution is acquired as a state variable related to operating conditions, and machine learning is performed, an appropriate cold isostatic pressing process condition can be decided in consideration of the operating conditions.

In the above-described machine learning method, the function may be updated using deep reinforcement learning.

According to this aspect, the function is updated using deep reinforcement learning, thus the update of the function can be performed accurately and quickly. Thus, a cold isostatic pressing process condition can be derived more efficiently.

In the above-described machine learning method, in the calculation of the reward, when the at least one physical amount approaches a predetermined reference value corresponding to the one physical amount, the reward may be increased.

With this configuration, as the physical amount approaches a reference value, the reward is increased, thus it is possible for the physical amount to reach the reference value quickly.

Note that in the disclosure, each process included in the above-described machine learning method may be implemented in the machine learning device, or may be implemented and distributed as a machine learning program. The machine learning device may be comprised of a server or comprised of a cold isostatic pressing apparatus.

A communication method according to another aspect of the disclosure provides a communication method of a control device of a cold isostatic pressing apparatus to be trained by machine learning a cold isostatic pressing process condition for the cold isostatic pressing apparatus that performs a cold isostatic pressing process using a pressure medium for an object to be processed, the cold isostatic pressing apparatus including: a pressure vessel that stores the object to be processed, a compressor that supplies the pressure medium to the pressure vessel, a pressure adjustment mechanism configured to adjust a pressure in the pressure vessel, and the control device. The control device observes a state variable including at least one physical amount related to the object to be processed, and at least one cold isostatic pressing process condition, the control device transmits the variable state to a server via a network, and receives at least one machine-learned cold isostatic pressing process condition from the server, the at least one cold isostatic pressing process condition is generated by the server that calculates a reward for a result of decision of the at least one cold isostatic pressing process condition based on the state variable, updates, based on the reward, a function to decide the at least one cold isostatic pressing process condition from the state variable while changing the at least one cold isostatic pressing process condition, and decides a cold isostatic pressing process condition which yields a highest reward, by repeating update of the function, the at least one cold isostatic pressing process condition is at least one of a first parameter related to the object to be processed, a second parameter related to a preceding process of the cold isostatic pressing process, and a third parameter related to operating conditions of the cold isostatic pressing apparatus, the at least one physical amount being at least one of a physical amount related to sterilization and inactivation, a physical amount related to shucking, a physical amount related to improvement of taste and flavor, and a physical amount related to improvement of texture and nourishment of the object to be processed.

According to this aspect, information necessary for learning a cold isostatic pressing process condition by machine learning is provided. Such a communication method can be implemented in a cold isostatic pressing apparatus.

A control device according to another aspect of the disclosure provides a control device for a cold isostatic pressing apparatus that performs a cold isostatic pressing process using a pressure medium for an object to be processed, the cold isostatic pressing apparatus including: a pressure vessel that stores the object to be processed, a compressor that supplies the pressure medium to the pressure vessel, a pressure adjustment mechanism configured to adjust a pressure in the pressure vessel, a state observer that observes a state variable including at least one physical amount related to the object to be processed, and at least one cold isostatic pressing process condition, and a communication unit that transmits the variable state to a server via a network, and receives at least one machine-learned cold isostatic pressing process condition from the server. The at least one cold isostatic pressing process condition is generated by the server that calculates a reward for a result of decision of the at least one cold isostatic pressing process condition based on the state variable, updates, based on the reward, a function to decide the at least one cold isostatic pressing process condition from the state variable while changing the at least one cold isostatic pressing process condition, and decides a cold isostatic pressing process condition which yields a highest reward, by repeating update of the function, the at least one cold isostatic pressing process condition is at least one of a first parameter related to the object to be processed, a second parameter related to a preceding process of the cold isostatic pressing process, and a third parameter related to operating conditions of the cold isostatic pressing apparatus, the at least one physical amount being at least one of a physical amount related to sterilization and inactivation, a physical amount related to shucking, a physical amount related to improvement of taste and flavor, and a physical amount related to improvement of texture and nourishment of the object to be processed.

According to the disclosure, an appropriate cold isostatic pressing process condition for an object to be processed can be derived efficiently.

### BRIEF DESCRIPTION OF THE DRAWINGS

FIG. 1 is an entire configuration diagram of a CIP apparatus as a target to be trained in an embodiment of the disclosure;

FIG. 2 is an entire configuration diagram of a machine learning system that trains the CIP apparatus through machine learning in an embodiment of the disclosure;

FIG. 3 is a chart illustrating an example of CIP process conditions;

FIG. 4 is a graph illustrating an example of change in pressure and temperature in a pressure vessel during a CIP process;

FIG. 5 is a chart illustrating an example of physical amounts of an object to be processed;

FIG. 6 is a chart illustrating an example of physical amounts of an object to be processed;

FIG. 7 is a flowchart illustrating an example of a process in the machine learning system illustrated in FIG. 2; and

FIG. 8 is an entire configuration diagram of a machine learning system according to a modified embodiment of the disclosure.

### DESCRIPTION OF THE PREFERRED EMBODIMENTS

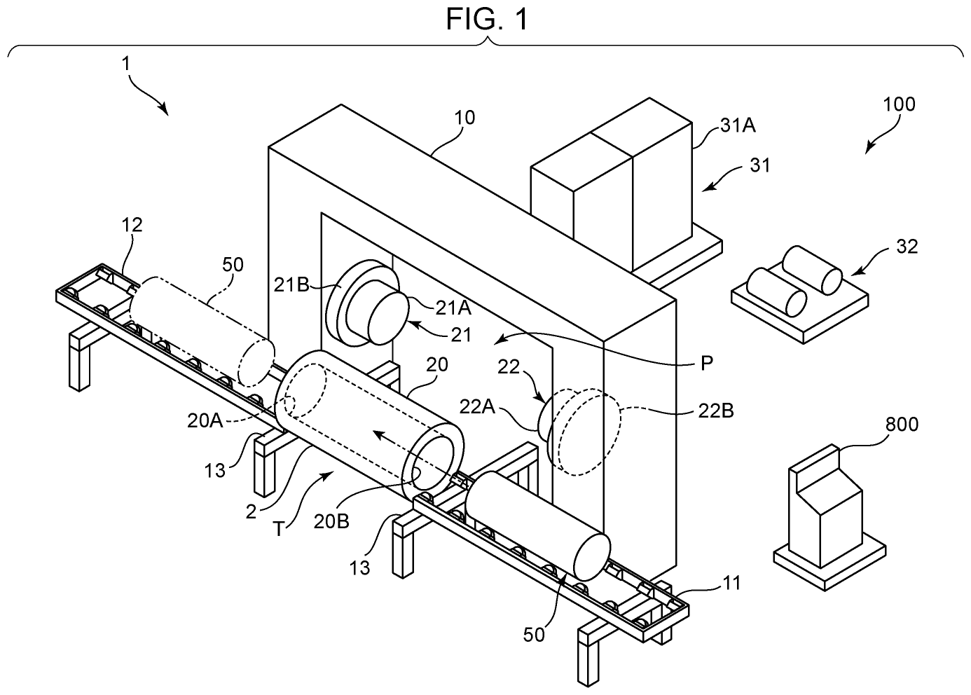

Hereinafter, a CIP apparatus 100 (a cold isostatic pressing apparatus, an isostatic pressing apparatus) according to an embodiment of the disclosure will be described with reference to the drawings. FIG. 1 is an entire configuration diagram of the CIP apparatus 100 as a target to be trained in an embodiment of the disclosure. The CIP apparatus 100 performs an isostatic pressing process on an object to be processed using a pressure medium.

Note that in the following description, a target object to be processed is assumed to be a food item; however, the object to be processed may be a product (for example, a beverage) other than food.

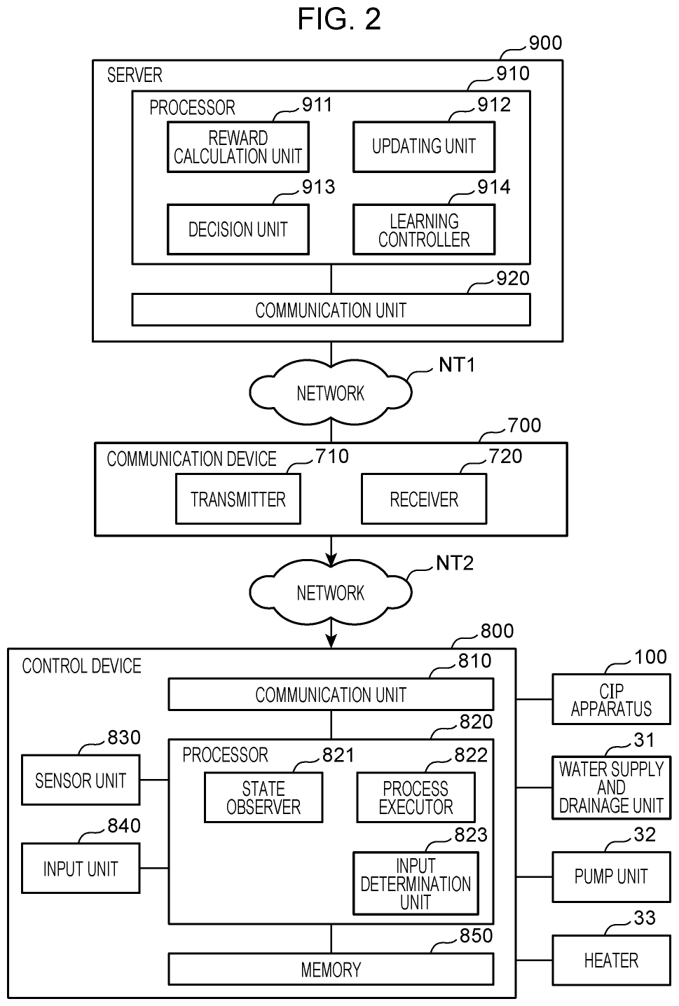

The CIP apparatus 100 according to an embodiment of the disclosure includes a pressure vessel 2, a storage vessel 50, a pressed frame 10, a carry-in rail 11, a carry-out rail 12, a movement rail 13, a water supply and drainage unit 31 (pressure medium supply mechanism), a pump unit 32 (pressurizing mechanism), a heater 33 (FIG. 2), and a control device 800.

The pressure vessel 2 stores an object to be processed internally, and performs an isostatic pressing process on the object to be processed. The pressure vessel 2 has a vessel body 20, a first lid 21, and a second lid 22. The pressure vessel 2 is composed of a metal material such as stainless steel in order to have a high pressure resistance.

The vessel body 20 includes a cylindrical inner circumferential surface formed around a central axis extending in a horizontal direction. In the vessel body 20, the processing space defined by the inner circumferential surface is formed, and both axial ends of the inner circumferential surface are each open (FIG. 1).

The first lid 21 and the second lid 22 are mounted on the both axial ends of the vessel body 20 to seal the processing space.

The first lid 21 and the second lid 22 have a water supply and drainage path which is not illustrated. The water supply and drainage path allows the outside of each lid and the processing space to communicate with each other, and the pressure medium after the pressing process is discharged from the processing space through the water supply and drainage path. In addition, the water supply and drainage path communicates with the water supply and drainage unit 31, and the pump unit 32 via a flow path (not illustrated), and the pressure medium flows into the processing space through the water supply and drainage path. An openable and closable valve which is not illustrated is disposed in the water supply and drainage path as necessary.

The storage vessel 50 stores an object to be processed and is disposed in the processing space of the pressure vessel 2 (see an arrow of FIG. 1). In this embodiment, a storage space capable of storing the object to be processed is formed in the inside of the storage vessel 50.

In the embodiment, the storage vessel 50 is composed of a material having a lower thermal conductivity than the pressure vessel 2. Specifically, the storage vessel 50 may be made of vinyl chloride, MC nylon, or Teflon (registered trademark). Alternatively, these materials may be used in part of the storage vessel 50. With this configuration, heat retention property of the storage vessel 50 can be maintained at a high level. In contrast, the pressure vessel 2 is composed of a metal material having a high pressure resistance in order to perform a pressing process.

The pressed frame 10 (FIG. 1) has a function of supporting an axial force applied to both-end lids of the pressure vessel 2. The pressed frame 10 has a frame structure, and when the pressure vessel 2 is disposed at a pressure position P in the frame, the object to be processed in the pressure vessel 2 undergoes an isostatic pressing process.

The movement rail 13 guides the vessel body 20 so that the vessel body 20 of the pressure vessel 2 is movable between the pressure position P and standby position T. The vessel body 20 receives a driving force of a drive mechanism which is not illustrated, and moves between the pressure position P and the standby position T. As illustrated in FIG. 1, the standby position T is a position away from the pressure position P. Note that the first lid 21 and the second lid 22 of the pressure vessel 2 are always disposed at the pressure position P. When the vessel body 20 is disposed at the pressure position P, the first lid 21 and the second lid 22 are moved in an axial direction by a drive cylinder which is not illustrated, and are mounted on both ends of the vessel body 20.

The carry-in rail 11 guides the storage vessel 50 to the inside of the vessel body 20 which is in standby at the standby position T before the pressing process. In contrast, the carry-out rail 12 guides the storage vessel 50 to be pulled out from the vessel body 20 which is moved to the standby position T after the pressing process.

The water supply and drainage unit 31 contains a tank 31A, and supplies a pressure medium to the processing space of the pressure vessel 2. In the embodiment, water or warm water is used as a pressure medium. The water supply and drainage unit 31 functions as a compressor of the disclosure.

The pump unit 32 pressurizes the pressure medium enclosed in the processing space. In the embodiment, a pressure medium is supplied to the processing space and concurrently, the pressure medium is pressurized by the pump unit 32. The pump unit 32 functions as a pressure adjustment mechanism of the disclosure. The pump unit 32 can adjust the pressure in the pressure vessel 2.

The heater 33 (FIG. 2) is disposed in the inside of the pressure vessel 2, and preheats or heats an object to be processed before the pressing process or during the pressing process for the object to be processed. The heater 33 may be disposed in the storage vessel 50. The heater 33 includes a thermocouple which is not illustrated, and is capable of adjusting the amount of heat generation according to a result of temperature detection. The heater 33 functions as the temperature adjustment mechanism of the disclosure. The heater 33 can adjust the temperature of the pressure medium in the pressure vessel 2. In the embodiment, the temperature of the pressure medium in the pressure vessel 2 is lower than the temperature (a high temperature of 100 degrees Celsius to 2,000 degrees Celsius) of the pressure medium in a publicly known hot isostatic pressing (HIP) apparatus, and is 100 degrees Celsius or lower as an example.

The control device 800 controls the operation of the water supply and drainage unit 31, the pump unit 32, the heater 33, and the above-mentioned drive mechanism and drive cylinder. The control device 800 has a control panel which is not illustrated. The control device 800 is comprised of a computer, and is responsible for the entire control of the CIP apparatus 100.

When the isostatic pressing process is performed on an object to be processed in the CIP apparatus 100 as described above, first, the CIP apparatus 100 including the pressure vessel 2 and the storage vessel 50 is prepared (preparation step). As described above, the vessel body 20 of the pressure vessel 2 is disposed at the standby position T on the movement rail 13, and the first lid 21 and the second lid 22 of the pressure vessel 2 are disposed on the pressed frame 10. The storage vessel 50 is disposed on the carry-in rail 11. A worker opens a lid (not illustrated) of the storage vessel 50 to store an object to be processed, such as a food item, in the storage vessel 50 (object to be processed storage step). In this process, the pressure medium (or the object to be processed) in the storage vessel 50 may be heated (preheated) to around 80° C. by the heater 33, for example.

Next, the worker inserts the storage vessel 50 into the inside of the vessel body 20 along the carry-in rail 11 (storage vessel disposition step). In addition, the worker operates the control device 800 to install the vessel body 20 at the pressure position P in the pressed frame 10 along the movement rail 13. At the pressure position P on the movement rail 13, the first lid 21 and the second lid 22 are disposed to be opposed to the vessel body 20. When the vessel body 20 is disposed at the pressure position P, a drive cylinder (not illustrated) extends, and the first lid 21 and the second lid 22 are each mounted on the vessel body 20 via a pressure receiving board which is not illustrated. As a result, the processing space of the pressure vessel 2 is brought into a sealed state.

Next, upon receiving an operation command from the worker, the control device 800 controls the water supply and drainage unit 31 to supply water at a room temperature (for example, 20° C.) from the water supply and drainage unit 31 into the processing space of the pressure vessel 2. The water is poured to fill the processing space of the pressure vessel 2 and the storage space of the storage vessel 50.

Next, the control device 800 controls the pump unit 32 to pressurize the water in the processing space (isostatic pressing process, pressing process step). In this process, since the volume of the water in the processing space decreases due to the pressing, water at a room temperature is additionally supplied. At the time of pressing, the pressure in the processing space is set to approximately 600 MPa. Application of a high pressure to the object to be processed in the storage vessel 50 for a predetermined time exhibits a high bactericidal effect on the object to be processed. Note that during the pressing, the pressure medium (the object to be processed) in the storage vessel 50 may be heated to around 80° C. by the heater 33, for example.

When the pressing process is completed, a depressurization process is performed on the processing space. Specifically, water is discharged through the water supply and drainage path of the first lid 21 and the second lid 22. In this process, when water is discharged from the processing space, due to the differential pressure between the processing space and the storage space, the pressure medium is discharged from the storage space to the processing space to depressurize the pressure vessel as the pressure in the storage space approaches the atmospheric pressure (depressurization process step).

Subsequently, a drive cylinder which is not illustrated separates the first lid 21 and the second lid 22 from the vessel body 20 via a pressure receiving board. Subsequently, the vessel body 20 containing the storage vessel 50 is moved to the standby position T again (FIG. 1). The storage vessel 50 is then is pulled out from the vessel body 20 along the carry-out rail 12, and the object to be processed after undergoing the pressing process is taken out from the storage vessel 50.

FIG. 2 is an entire configuration diagram of a machine learning system that trains the CIP apparatus 100 in the embodiment. In addition to the control device 800 illustrated in FIG. 1, the machine learning system (machine learning device) includes a server 900 (management device) and a communication device 700. The server 900 and the communication device 700 are coupled to each other via a network NT1 to enable communication therebetween. The communication device 700 and the control device 800 are coupled to each other via a network NT2 to enable communication therebetween. The network NT1 is, for example, a wide area communication network such as the Internet. The network NT2 is, for example, a local area network. The server 900 is, for example, a cloud server comprising one or more computers. The communication device 700 is, for example, a computer owned by a user using the control device 800. The communication device 700 functions as a gateway to connect the control device 800 to the network NT1. The communication device 700 is implemented by installing a dedicated application software in a computer owned by the user. Alternatively, the communication device 700 may be a dedicated device provided to a user by the manufacturer of the CIP apparatus 100. As described above, the control device 800 is a control device that controls the CIP apparatus 100 described with reference to FIG. 1.

Hereinafter, the configuration of each device will be specifically described. The server 900 includes a processor 910 and a communication unit 920. The processor 910 is a control device including a CPU and the like. The processor 910 includes a reward calculation unit 911, an updating unit 912, a decision unit 913, and a learning controller 914. Each unit included in the processor 910 may be implemented by the processor 910 executing a machine learning program which causes a computer to function as the server 900 in the machine learning system, or may be implemented by a dedicated electrical circuit.

The reward calculation unit 911 calculates a reward to a result of decision of at least one CIP process condition based on a state variable observed by a state observer 821.

The updating unit 912 updates a function to decide a CIP process condition from the state variable observed by the state observer 821, based on the reward calculated by the reward calculation unit 911. As the function, the later-described action value function is used.

The decision unit 913 repeats update of the function while changing at least one CIP process condition, thereby deciding a CIP process condition which yields a highest reward.

The learning controller 914 is responsible for the entire control of machine learning. The machine learning system of the embodiment learns CIP process conditions by reinforcement learning. The reinforcement learning is a machine learning technique in which an agent (an action agent) selects a certain action based on the environmental conditions, changes the environment based on the selected action, and trains the agent to learn selection of a better action by giving a reward according to the environmental change to the agent. As the reinforcement learning, Q-learning and TD learning can be used. In the following description, Q-learning will be described as an example. In the embodiment, the reward calculation unit 911, the updating unit 912, the decision unit 913, the learning controller 914 and the later-described state observer 821 correspond to an agent. In the embodiment, the communication unit 920 is an example of a state acquisition unit that acquires a state variable.

The communication unit 920 is comprised of a communication circuit that connects the server 900 to the network NT1. The communication unit 920 receives a state variable observed by the state observer 821 via the communication device 700. The communication unit 920 transmits the CIP process condition decided by the decision unit 913 to the control device 800 via the communication device 700.

The communication device 700 includes a transmitter 710 and a receiver 720. The transmitter 710 transmits the state variable transmitted from the control device 800 to the server 900, and transmits the CIP process condition transmitted from the server 900 to the control device 800. The receiver 720 receives the state variable transmitted from the control device 800, and receives the CIP process condition transmitted from the server 900.

The control device 800 includes a communication unit 810, a processor 820, a sensor unit 830, an input unit 840, and a memory 850.

The communication unit 810 is a communication circuit that connects the control device 800 to the network NT2. The communication unit 810 transmits the state variable observed by the state observer 821 to the server 900. The communication unit 810 receives a CIP process condition decided by the decision unit 913 of the server 900. The communication unit 810 receives the later-described CIP process execution command decided by the learning controller 914.

The processor 820 is a computer including a CPU and the like. The processor 820 includes a state observer 821, a process executor 822, and an input determination unit 823. The communication unit 810 transmits a state variable acquired by the state observer 821 to the server 900. Each unit included in the processor 820 is implemented, for example, by a CPU executing a machine learning program which causes a computer to function as the control device 800 of the machine learning system.

After execution of a CIP process, the state observer 821 acquires a physical amount detected by the sensor unit 830. After execution of a CIP process, the state observer 821 observes a state variable including at least one physical amount related to the object to be processed, and at least one CIP process condition. Specifically, the state observer 821 acquires a CIP process condition based on measured values of the sensor unit 830. In addition, the state observer 821 acquires a physical amount based on measured values of the sensor unit 830. In the embodiment, the at least one physical amount related to an object to be processed is a physical amount related to sterilization and inactivation, a physical amount related to shucking, a physical amount related to improvement of taste and flavor, or a physical amount related to improvement of texture and nourishment.

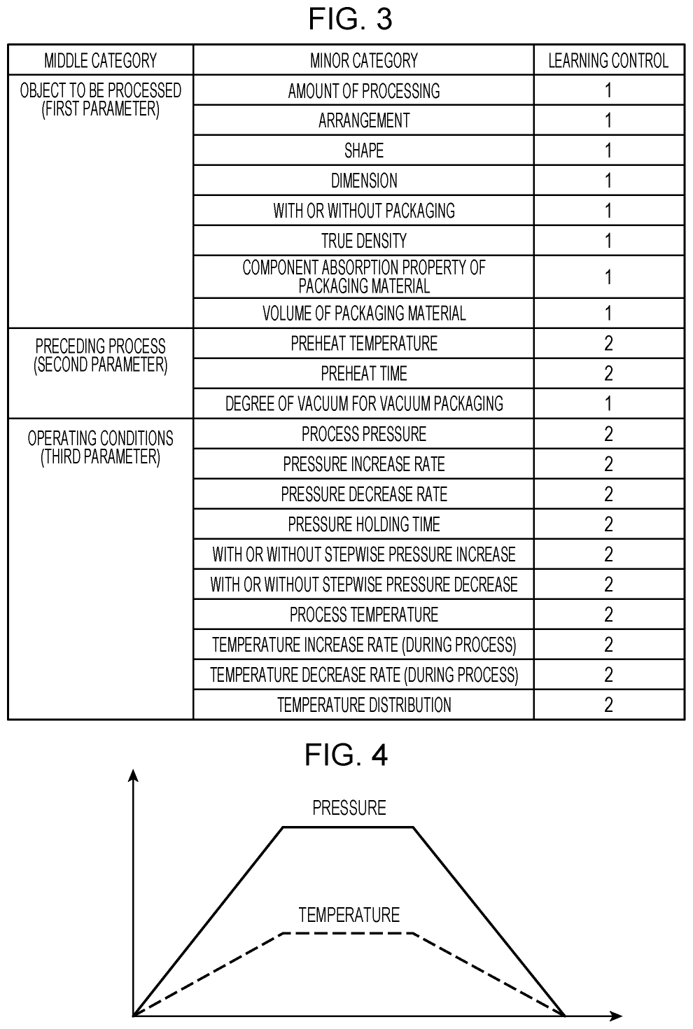

FIG. 3 is a chart illustrating an example of CIP process conditions. The CIP process conditions are broadly classified into middle categories. The middle categories each include at least one of a first parameter related to an object to be processed, a second parameter related to a preceding process of a CIP process, and a third parameter related to operating conditions for the CIP apparatus 100. In the learning control in the table, each parameter denoted as “1” is a parameter for which a value is specified by a user operating the input unit 840, and is not a parameter learned by machine learning. Therefore, in the embodiment, each parameter not denoted as “1”, specifically each parameter denoted as “2” is a target to be trained. However, this is just an example, and one or multiple of the parameters denoted as “1” may be a target to be trained.

As a minor category, the first parameter includes at least one of an amount of processing, an arrangement, a shape, a dimension, with or without packaging, a true density, a component absorption property of a packaging material and a volume of a packaging material. The amount of processing indicates the amount to be processed per batch, specifically, the amount of an object to be processed stored in the storage vessel 50 in one CIP process. The arrangement indicates how the object to be processed is arranged in the storage vessel 50. The shape indicates the external shape of the object to be processed. For example, as the shape, information such as sphere, prolate spheroid, oblate spheroid, rectangular parallelepiped, cube, cylindrical shape may be used. The reason why the shape is included in the CIP process conditions is that there is a possibility that the result of a CIP process is changed by the shape of the object to be processed. As the dimension, information such as width, height and depth is used when the object to be processed is a rectangular parallelepiped, and information such as average diameter and height is used when the object to be processed has a cylindrical shape. The with or without packaging indicates whether the object to be processed is packaged at the time of process, and indicates, for example, whether vacuum packaging is provided. The true density indicates the density of the object to be processed. The component absorption property of a packaging material indicates the absorption property (likelihood of adsorption) of the surface of a packaging material by which an object to be processed is packaged. The volume of a packaging material indicates the volume of a packaging material by which an object to be processed is packaged. In other embodiments, when the shape and dimension of an object to be processed are used as parameters which are learned by machine learning, these values can be observed using a camera or a three-dimensional measuring instrument, for example.

As described above, an amount of processing, an arrangement, a shape, a dimension, with or without packaging and a true density are each inputted by a user via the input unit 840. Thus, the state observer 821 only has to obtain these parameters from the input unit 840.

As a minor category, the second parameter includes a preheat temperature, a preheat time, and a degree of vacuum for vacuum packaging. The preheat temperature indicates the temperature at which a preheat process is performed on an object to be processed before a CIP process (pressing process). Similarly, the preheat time indicates the time during which a preheat process is performed on an object to be processed before a CIP process. The degree of vacuum for vacuum packaging indicates the degree of vacuum when an object to be processed is vacuum-packed. These second parameters are each inputted by a user via the input unit 840. Thus, the state observer 821 only has to obtain these parameters from the input unit 840.

As a minor category, the third parameter includes a process pressure, a pressure increase rate, a pressure decrease rate, a pressure holding time, with or without stepwise pressure increase, with or without stepwise pressure decrease, a process temperature, a temperature increase rate (during a process), a temperature decrease rate (during a process), and a temperature distribution. The process pressure indicates the pressure in the pressure vessel 2 during a CIP process. The pressure increase rate and the pressure decrease rate each indicate a rate of change in pressure over a period before and after a CIP process. Note that the pressure decrease rate also includes secondary pressure decrease. The pressure decrease rate varies in a range under a predetermined secondary pressure decrease setting value. The pressure holding time indicates the time during which a CIP process is performed on the object to be processed. The with or without stepwise pressure increase indicates whether the pressure is increased stepwise at the time of a CIP process until a certain process pressure is reached. Similarly, the with or without stepwise pressure decrease indicates whether the pressure is decreased stepwise from a certain process pressure at the time of a CIP process. The process temperature indicates the temperature in the pressure vessel 2 during a CIP process. The temperature increase rate (during a process) indicates the rate of temperature increase in the pressure vessel 2 during a CIP process. Similarly, the temperature decrease rate (during a process) indicates the rate of temperature decrease in the pressure vessel 2 during a CIP process. The temperature distribution indicates the temperature distribution in the pressure vessel 2 formed by adjusting the amount of heat generation of each of multiple heaters 33 which are disposed in a predetermined direction in the pressure vessel 2.

FIG. 4 is a graph illustrating an example of change in pressure and temperature in the pressure vessel 2 during a CIP process. In FIG. 4, the vertical axis indicates pressure and temperature, and the horizontal axis indicates time. In this example, the change in pressure and temperature follows a trapezoidal shape. The pressure and the temperature each increase with a constant slope until a maximum pressure and a maximum temperature are respectively reached, the maximum pressure (process pressure) and the maximum temperature (process temperature) are maintained for a certain time, then the pressure and the temperature each decrease with a constant slope. As described above, for the pressure, machine learning is performed by changing a process pressure, a slope (pressure increase rate) at the time of pressure increase, a slope (pressure decrease rate) at the time of pressure decrease, a time (pressure holding time) of maintaining a maximum pressure, and with or without stepwise pressure increase, and stepwise pressure decrease. In addition, for the temperature, machine learning is performed by changing a process temperature, a slope (temperature increase rate) at the time of temperature increase, a slope (temperature decrease rate) at the time of temperature decrease, a time of maintaining a maximum temperature, and a temperature distribution. For an operating condition related to pressure, data inputted by a user via the input unit 840 may be used, or measured values of a pressure sensor (not illustrated) included in the water supply and drainage unit 31 may be used. For other parameters mentioned above, data inputted by a user via the input unit 840 is used.

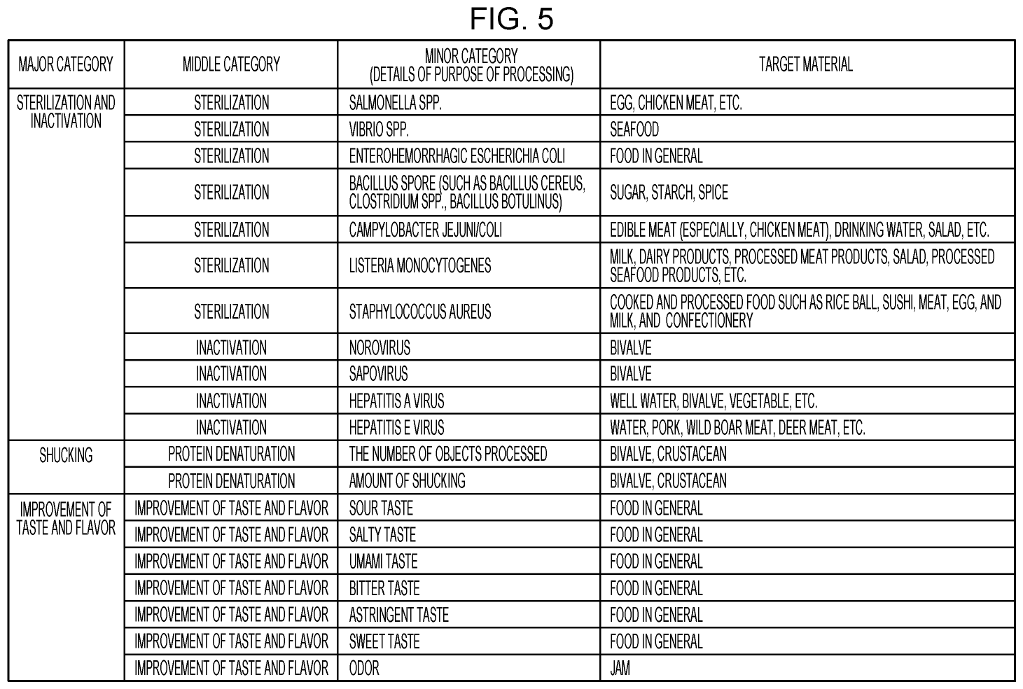

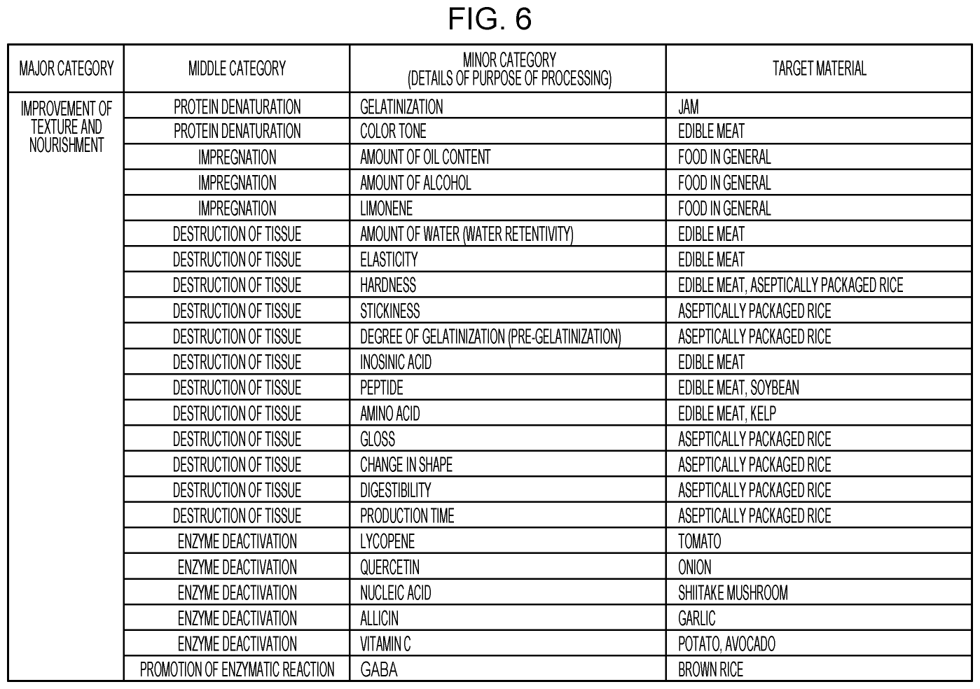

FIG. 5 and FIG. 6 are each a chart illustrating an example of physical amounts of an object to be processed. As a major category, the physical amount includes a physical amount related to sterilization and inactivation, a physical amount related to shucking, a physical amount related to improvement of taste and flavor, and a physical amount related to improvement of texture and nourishment.

The sterilization and inactivation is broadly classified into sterilization and inactivation. A middle category of sterilization is classified into multiple minor categories according to the purpose of process. The minor categories include the bacterial count of each of Salmonella spp., Vibrio spp., Enterohemorrhagic Escherichia coli, spore bacteria (such as Bacillus cereus, Clostridium spp., Bacillus botulinus), Campylobacter jejuni/coli, Listeria monocytogenes, and Staphylococcus aureus. In addition, the middle category of inactivation is also classified into multiple minor categories according to the details of the purpose of process. The minor categories include the virus counts of each of norovirus, sapovirus, hepatitis A virus, and hepatitis E virus.

The minor category of salmonella spp. is for the purpose of sterilizing the salmonella spp., and is directed to egg, chicken meat, etc., as an example. For measurement of Salmonella spp., a test method in compliance with ISO6579, or the standard test method for Salmonella spp., NIHSJ-01 prescribed by National Institute of Health Sciences may be used.

A minor category of Vibrio spp., is for the purpose of sterilizing the Vibrio spp., and is directed to seafood, as an example. For measurement of Vibrio spp., a test method in compliance with ISO21872, or the standard test method for Vibrio parahaemolyticus, NIHSJ-07 prescribed by National Institute of Health Sciences may be used.

A minor category of Enterohemorrhagic Escherichia coli is for the purpose of sterilizing the Enterohemorrhagic Escherichia coli, and is directed to food in general. For measurement of Enterohemorrhagic Escherichia coli, a test method in compliance with ISO16654, or “the inspection method for Enterohemorrhagic Escherichia coli O26, O103, O111, O121, O145 and O157” prescribed by Ministry of Health, Labor and Welfare may be used.

A minor category of spore bacteria is for the purpose of sterilizing the spore bacteria (such as Bacillus cereus, Clostridium spp., Bacillus botulinus), and is directed to sugar, starch, spice used to produce fish meat products for Bacillus cereus as an example, and is directed to specific heated processed meat products, meat products heated after being packaged, and the raw water of mineral water for Clostridium spp. as an example. For measurement of these bacteria, in the case of Bacillus cereus, as the pretreatment of a specimen, the specimen is heated in boiling water for 10 minutes, and aerobically cultivated on standard agar media at 30 degrees Celsius for 48 hours. In the case of Clostridium spp., as the pretreatment, a specimen is heated at 70 degrees Celsius for 20 minutes, and cultivated on media for Clostridium measurement (anaerobic pouch) at 35 degrees Celsius for 24 hours. In either case, determination can be made based on a bacterial count of 1000 or less per gram.

A minor category of Campylobacter jejuni/coli is for the purpose of sterilizing the Campylobacter jejuni/coli, and is directed to edible meat (especially, chicken meat), drinking water, salad, etc., as an example. For measurement of these bacteria, a test method in compliance with ISO10272, or the standard test method for Campylobacter, NIHSJ-02 prescribed by National Institute of Health Sciences may be used.

A minor category of Listeria monocytogenes is for the purpose of sterilizing the Listeria monocytogenes, and is directed to milk, dairy products, processed meat products, salad, processed seafood products, etc., as an example. For measurement of these bacteria, a test method in compliance with ISO11290, “the quantitative test method for Listeria monocytogenes” prescribed by Ministry of Health, Labor and Welfare, or the standard test method for Listeria monocytogenes, NIHSJ-09 prescribed by National Institute of Health Sciences may be used.

A minor category of Staphylococcus aureus is for the purpose of sterilizing the Staphylococcus aureus, and is directed to a wide variety of objects including cooked and processed food such as rice ball, sushi, meat, egg, and milk, and confectionery, as an example. For measurement of the Staphylococcus aureus, a test method in compliance with ISO6888, or the standard test methods for Staphylococcus aureus, NIHSJ-03, NIHSJ-05 prescribed by National Institute of Health Sciences may be used.

A minor category of norovirus is for the purpose of inactivating the norovirus, and is directed to bivalve etc., as an example. For measurement of the norovirus, a test method in compliance with ISO15216, or “the detection method (real-time PCR method) for norovirus” prescribed by Ministry of Health, Labor and Welfare may be used.

A minor category of sapovirus is for the purpose of inactivating the sapovirus, and is directed to bivalve etc., as an example. For measurement of the sapovirus, the real-time PCR method may be used.

A minor category of hepatitis A virus is for the purpose of inactivating the hepatitis A virus, and is directed to well water, bivalve, vegetable, etc., as an example. For measurement of the hepatitis A virus, a test method in compliance with ISO15216, or “the detection method (real-time PCR method) for hepatitis A virus” prescribed by National Institute of Health Sciences may be used.

A minor category of hepatitis E virus is for the purpose of inactivating the hepatitis E virus, and is directed to water, pork, wild boar meat, deer meat, etc., as an example. For measurement of the hepatitis E virus, publicly known cell culture method, genetic test method, or serum test method may be used.

The physical amount of shucking each corresponds to a middle category of protein denaturation. The middle category is classified into minor categories of the number of objects processed, and the amount of shucking according to the purpose of process.

The minor categories of the number of objects processed, and the amount of shucking are directed to bivalve, crustacean, as an example. As the measurement method for the minor categories, the number of processed objects achieved by a shucking process due to protein denaturation is counted, and a removed area is measured.

The physical amounts of improvement of taste and flavor each correspond to a middle category of improvement of taste and flavor. The middle category is classified into minor categories of sour taste, salty taste, umami taste, bitter taste, astringent taste, sweet taste, and smell according to the purpose of process. These minor categories are directed to food in general. A taste sensor may be used to measure sour taste, salty taste, umami taste, bitter taste, astringent taste, and sweet taste, and an odor sensor may be used to measure odor. Note that the category of odor may be directed to, specifically, a food item such as jam.

The physical amount of improvement of texture and nourishment is broadly classified into middle categories. The middle categories include protein denaturation, impregnation, destruction of tissue, enzyme deactivation, and promotion of enzymatic reaction. The middle category of protein denaturation is classified into minor categories of gelatinization, and color tone according to the purpose of process. Similarly, the middle category of impregnation is classified into minor categories of amount of oil content, amount of alcohol, and limonene. The middle category of destruction of tissue is classified into minor categories of amount of water (water retentivity), elasticity, hardness, stickiness, degree of gelatinization (pre-gelatinization), inosinic acid, peptide, amino acid, gloss, change in shape, digestibility, and production time. The middle category of enzyme deactivation is classified into minor categories of lycopene, quercetin, nucleic acid, allicin, and vitamin C. The middle category of promotion of enzymatic reaction corresponds to a minor category of gamma-amino butyric acid (GABA).

The minor category of gelatinization is for measuring the degree of gelatinization of an object to be processed due to protein denaturation, and is directed to a food item such as jam, as an example. For measurement of gelatinization, a publicly known rheometer may be used.

The minor category of color tone is for measuring disengagement of protoheme due to denaturation of globin protein, and is directed to edible meat, as an example. For measurement of color tone, a colorimeter, or a spectrophotometer may be used.

The minor categories of amount of oil content, amount of alcohol, and limonene are each directed to food in general. For measurement of the amount of oil content, an infrared multi-component meter, or an oil content meter may be used. For measurement of the amount of alcohol, an enzymatic method, liquid chromatography, a specific gravity method, an oxidation method, gas chromatography, or an ethanol sensor may be used. For measurement of limonene, gas chromatography may be used.

The minor categories of amount of water (water retentivity), elasticity, hardness, stickiness, degree of gelatinization (pre-gelatinization) are each for measuring characteristics which are changed due to destruction of cell walls, likely causing water to enter cells. The minor category of amount of water is directed to edible meat etc., and the amount of water can be measured by a moisture meter. Similarly, the minor category of elasticity is directed to edible meat, and elasticity can be measured by a rheometer. The minor category of hardness is directed to edible meat, aseptically packaged rice, etc., and hardness can be measure by a creep meter, and a texturometer. The minor category of stickiness is directed to aseptically packaged rice, etc., and stickiness can be measured by a rheometer. The minor category of degree of gelatinization (pre-gelatinization) is directed to aseptically packaged rice, etc., and the degree of gelatinization can be measured by the glucoamylase second method, the glucoamylase method, the diastase method, or the β-amylase-pullulanase method.

The minor categories of inosinic acid, peptide, and amino acid are each for measuring characteristics which are changed by elution of proteolytic enzyme due to destruction of cell walls. As an example, the minor category of inosinic acid is directed to edible meat, and the inosinic acid can be measured by a direct UV detection method, a fluorescent probe, or high-performance liquid chromatography. The minor category of peptide is mainly directed to edible meat, soybean etc., and peptide can be measured by a fluorescence method, or a highly sensitive enzyme immunoassay. The minor category of amino acid is directed to edible meat, kelp etc., and amino acid can be measured by an amino acid autoanalyzer.

The minor category of gloss is for measuring characteristics which are changed by high likelihood of absorption of water due to destruction of cell walls, and is mainly directed to aseptically packaged rice. For measurement of gloss, a publicly known gloss measuring device may be used. The minor category of change in shape is for measuring whether it is possible to destruct cell walls of an object to be processed while maintaining its shape, and is mainly directed to aseptically packaged rice. For measurement of the shape, a publicly known three-dimensional shape measuring device may be used. The minor category of digestibility is for measuring an improved digestibility due to destruction of cell walls of an object to be processed, and is mainly directed to aseptically packaged rice. For measurement of the digestibility, a sensory test may be used. The minor category of production time is for measuring characteristics which are changed by high likelihood of absorption of water due to destruction of cell walls, and is mainly directed to aseptically packaged rice. The production time can be measured in terms of a water absorption time of an object to be processed.

The minor categories of lycopene, quercetin, nucleic acid, allicin, and vitamin C are each for measuring a change in functional components due to enzyme deactivation. Measurement of lycopene is directed to a food item such as a tomato, and the lycopene can be measured by liquid chromatography or visible-near-infrared spectroscopy. Measurement of quercetin is directed to a food item such as an onion, and the quercetin can be measured by chopping a sample, then extracting quercetin with methanol to perform absorbance measurement, or by a measurement method such as liquid chromatography.

Measurement of nucleic acid is directed to a food item such as shiitake mushroom, and nucleic acid can be measured by absorption spectroscopy, a fluorescent method, or liquid chromatography-isotope dilution mass spectrometry. Measurement of allicin is directed to a food item such as garlic, and allicin can be measured by liquid chromatography. Measurement of vitamin C is directed to a food item such as a potato, an avocado, and vitamin C be measured by a hydrazine method.

GABA is for measuring characteristics which are changed by promotion of enzymatic reaction, and is directed to brown rice, etc., and can be measured by an amino acid autoanalyzer.

Reference is returned to FIG. 2. The process executor 822 controls the execution of the CIP process performed by the CIP apparatus 100. The input determination unit 823 automatically or manually determines whether a high-volume production process is ongoing. For automatic determination whether a high-volume production process is ongoing, when an input number for a condition number, inputted to the input unit 840 exceeds a reference number, the input determination unit 823 determines that the CIP apparatus 100 is in a high-volume production process. The condition number is an ID number to identify a CIP process condition. The CIP process conditions each identified by a condition number include at least the CIP process conditions with “1” specified among the CIP process conditions illustrated in FIG. 3.

For manual determination whether a high-volume production process is ongoing, when data indicating a high-volume production process is inputted to the input unit 840, the input determination unit 823 determines that the CIP apparatus 100 is in a high-volume production process. In the case of a high-volume production process, the control device 800 does not perform machine learning.

The memory 850 is, for example, a non-volatile storage device, and stores a finally determined optimal CIP process condition.

The sensor unit 830 refers to various sensors used for measurement of the CIP process conditions illustrated in FIG. 3 and the physical amounts of an object to be processed illustrated in FIG. 5, FIG. 6. Specifically, the sensor unit 830 includes a temperature sensor that measures the temperature in the pressure vessel 2, and a pressure sensor. In addition, the sensor unit 830 includes sensors that perform various measurement tests on an object to be processed taken out from the storage vessel 50 after completion of a CIP process performed on the object. In FIG. 2, the sensor unit 830 is provided in the inside of the control device 800; however, this is just an example, and the sensor unit 830 may be provided outside the control device 800, and the installation site of the sensor unit 830 is not particularly restricted. The input unit 840 is an input device such as a keyboard and a mouse.

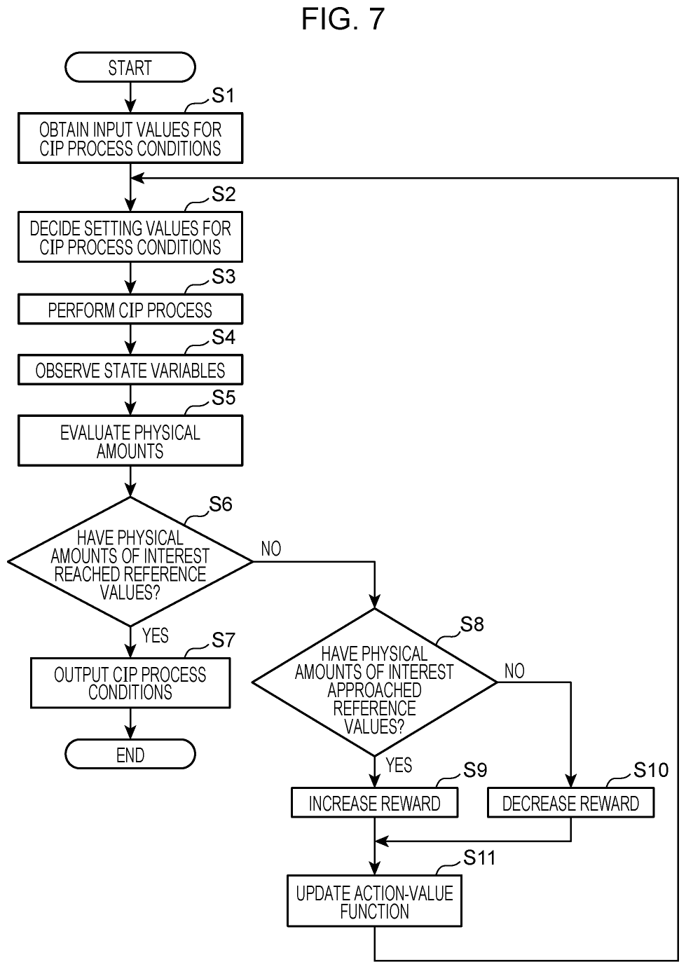

FIG. 7 is a flowchart illustrating an example of a process executed by the machine learning system illustrated in FIG. 2. In step S1, the learning controller 914 obtains an input value for a CIP process condition, inputted by a user using the input unit 840. The input value obtained here is for one of the CIP process conditions with “1” specified among the CIP process conditions listed in FIG. 3.

In step S2, the learning controller 914 decides at least one CIP process condition and a setting value for the CIP process condition. Here, a CIP process condition to be set is any of the CIP process conditions with “2” specified among the CIP process conditions listed in FIG. 3, and is at least one CIP process condition for which a setting value is settable. The setting value for a CIP process condition decided here corresponds to an action in reinforcement learning.

Specifically, the learning controller 914 selects a setting value at random for each of the CIP process conditions to be set. Here, a setting value is selected from a predetermined range at random for each of the CIP process conditions. As a method of selecting a setting value for a CIP process condition, the ε-greedy method may be used.

In step S3 the learning controller 914 transmits a CIP process execution command to the control device 800, thereby causing the CIP apparatus 100 to start a CIP process via the control device 800. When the CIP process execution command is received by the communication unit 810, the process executor 822 sets a CIP process condition according to the CIP process execution command, and starts a CIP process. The CIP process execution command includes the input value for the CIP process condition set in step S1 and the setting value decided in step S2 for the CIP process condition.

When the CIP process is completed, the state observer 821 observes a state variable (step S4). Specifically, as state variables, the state observer 821 acquires the physical amounts related to sterilization and inactivation, shucking, improvement of taste and flavor, and improvement of texture and nourishment described in FIG. 5, FIG. 6, and the CIP process conditions with a state observed by the sensor unit 830 among the CIP process conditions described in FIG. 3. The physical amounts may be inputted to the control device 800, for example, by a user operating the input unit 840, or may be inputted to the control device 800 via communication between a measuring instrument that measures a physical amount and the control device 800. The state observer 821 transmits the acquired state variable to the server 900 via the communication unit 810.

In step S5, the decision unit 913 evaluates a physical amount. Here, the decision unit 913 evaluates each of physical amounts by determining whether the physical amount to be evaluated (hereinafter referred to as a physical amount of interest) among the physical amounts acquired in step S4 has reached a predetermined reference value. The physical amount of interest refers to one or multiple of the physical amounts described in FIG. 5, FIG. 6. When multiple physical amounts of interest are present, multiple reference values are provided which correspond to the respective physical amounts of interest. As a reference value, a predetermined value may be used which indicates that the physical amount of interest reaches a certain standard, for example.

For example, when machine learning is performed for Salmonella spp., a predetermined value for Salmonella spp. is used as a reference value, and when machine learning is performed for gelatinization, a predetermined value for gelatinization is used as a reference value. The reference value may be a value between a lower limit value and an upper limit value inclusively, for example. In this case, when a physical amount of interest is in the range from a lower limit value to an upper limit value inclusively, it is determined that a reference value is reached. The reference value may refer to one value. In this case, when a physical amount of interest exceeds a reference value or when a physical amount of interest falls below a reference value, it is determined that a certain standard is met.

When determining that the physical amount of interest reaches a reference value (YES in step S6), the decision unit 913 outputs the CIP process condition set in step S2 as the final CIP process condition (step S7). In contrast, when determining that the physical amount of interest has not reached a reference value (NO in step S6), the decision unit 913 proceeds the process to step S8. Note that, provided that multiple physical amounts of interest are present, when all physical amounts of interest reach respective reference values, the decision unit 913 may determine YES in step S6.

In step S8, the reward calculation unit 911 determines whether the physical amount of interest has approached a reference value. When the physical amount of interest has approached a reference value (YES in step S8), the reward calculation unit 911 increases the reward to the agent (step S9). In contrast, when the physical amount of interest has not approached a reference value (NO in step S8), the reward calculation unit 911 decreases the reward to the agent (step S10). In this case, the reward calculation unit 911 only has to increase or decrease the reward according to an increased or decreased value to or from a predetermined reward. Note that when multiple physical amounts of interest are present, the reward calculation unit 911 only has to make determination in step S8 for each of the multiple physical amounts of interest. In this case, the reward calculation unit 911 only has to increase or decrease the reward based on the result of determination in step S8 for each of the multiple physical amounts of interest. Note that respective different increased or decreased values of reward may be used according to the physical amounts of interest.

When the physical amount of interest has not approached a reference value (NO in step S8), the process to decrease the reward (step S10) may be omitted. In this case, only when the physical amount of interest has approached a reference value, the reward is given.

In step S11, the updating unit 912 updates the action value function using the reward given to the agent. The Q-learning used in the embodiment is a method in which Q-value (Q (s, a)) is learned which is a value for selecting an action a under a certain environmental state s. Note that the environmental state st corresponds to the state variable of the flow described above. In the Q-learning, under a certain environmental state s, an action a having a highest Q(s, a) is selected. In the Q-learning, various actions a are taken by trial and error under a certain environmental state s, and correct Q(s, a) is learned using the reward at that time. The update expression for the action value function Q(st, at) is shown in the following Expression (1).

$$\begin{matrix}[ Expression 1 ] & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

Here, st, at represent the environmental state and the action at time t, respectively. The environmental state is changed to st+1 by the action at, and reward rt+1 is calculated using the change of the environmental state. In addition, the term with max is the product of γ and Q-value (Q (st+1, a)) when action a is selected which has the highest value known at the moment under the environmental state st+1. Here, γ is a discount rate, and has a value of 0<γ≤1 (normally, 0.9 to 0.99). Here, α is a learning coefficient, and has a value of 0<α≤1 (normally, around 0.1).

The update expression is such that when γ maxQ(st+1, a) is greater than Q(st, at) which is the Q-value of action a in state s, Q(st, at) is updated and increased, the γ maxQ(st+1, a) being based on the Q-value when the optimal action is taken by the action a in the subsequent environmental state st+1. In contrast, the update expression is such that when γ maxQ(st+1, a) is less than Q(st, at), Q(st, at) is updated and decreased. In other words, the value of an action a in a state st is made closer to the value of an optimal action in the subsequent state st+1. Consequently, an optimal CIP process condition is decided.

When the process in step S11 is completed, the process returns to step S2, and the setting value for the CIP process condition is changed, and similarly, the action value function is updated. The updating unit 912 updates the action value function; however, the invention is not limited to this, and an action value table may be updated.

The values Q(s, a) for the pairs (s, a) of all states and actions may be stored in a table format. Alternatively, the values Q(s, a) for the pairs (s, a) of all states and actions may be represented by an approximate function. The approximate function may be formed by a neural network having a multilayer structure. In this case, the neural network only has to perform online learning in which data obtained by actually operating the CIP apparatus 100 is learned in real-time, and reflected on the next action. Thus, deep reinforcement learning is implemented.

Specifically, in reinforcement learning, a machine learning system learns actions to maximize a reward (score) set as an object in a predetermined environment. In contrast, in deep learning, representation learning can be achieved by providing multiple intermediate layers of a neural network so that a machine learning system itself extracts feature values from learning data and constructs a prediction model. Therefore, in deep reinforcement learning in which deep learning is applied to reinforcement learning in the embodiment, the machine learning system can extract preferred feature values from the CIP process conditions (the first parameter, the second parameter, the third parameter) illustrated in FIG. 3, and the physical amounts of an object to be processed illustrated in FIG. 5, FIG. 6. In this process, for feature values affecting to each other (interacting effects) such as the process pressure and the process temperature in the operating conditions of FIG. 3, new feature values (for example, the ratio of pressure to temperature) including those feature values may be extracted and changed by the machine learning system. With this configuration, CIP process conditions ensuring high reward can be obtained efficiently and more quickly. The deep reinforcement learning as described above is performed in advance for a high-volume production process, thereby making it possible to implement a high-volume production process based on desirable CIP process conditions.

In the past, CIP process conditions have been developed in CIP apparatuses to obtain high-quality CIP process products by changing the CIP process conditions. In order to obtain favorable CIP process conditions, it is required that a relationship between evaluation of an object to be processed and CIP process condition be found. However, the types of CIP process conditions are enormous as illustrated in FIG. 3, thus significantly many physical models are necessary to define such a relationship, and knowledge has been obtained that it is difficult to describe such a relationship by physical models. In addition, to construct such a physical model, it is required to artificially find which parameter affects the evaluation of which object to be processed, thus the construction is difficult.

According to the embodiment, at least one of the first to third parameters described above, and at least one of a physical amount related to sterilization and inactivation, a physical amount related to shucking, a physical amount related to improvement of taste and flavor, and a physical amount related to improvement of texture and nourishment are observed as state variables. A reward for a result of decision of a CIP process condition is then calculated based on the observed state variables, the action value function to decide a CIP process condition from the state variables is updated based on the calculated reward, and a CIP process condition which yields a highest reward is learned by repeating the update. In this manner, in the embodiment, CIP process conditions are decided by machine learning without using the above-described physical model. As a result, in the embodiment, an appropriate CIP process condition can be decided efficiently and easily without relying on the experience of an expert engineer for long years.

Particularly, when water or the like is flowed into the pressure vessel 2 as a pressure medium to perform CIP process on an object to be processed, the physical amounts (FIG. 5, FIG. 6) of the object to be processed change while various process conditions illustrated in FIG. 3 interacting with each other. For example, when the arrangement, shape, and dimension of aseptically packaged rice in the pressure vessel 2 (the storage vessel 50) are changed as the first parameter related to an object to be processed, even with the same process pressure (the operating conditions, the third parameter), the action of pressure on each packaged rice is changed, and as a consequence, a difference in stickiness (improvement of texture and nourishment in FIG. 6) may occur. It is difficult to find such effects on the physical amounts using many physical models. In contrast, according to the embodiment, desirable CIP process conditions can be efficiently decided by the machine learning system that learns CIP process conditions yielding a higher reward while updating the action value function. In this process, as described above, application of deep reinforcement learning to the machine learning system enables the system itself to extract new feature values, and derive appropriate CIP process conditions more efficiently and quickly.

As described above, in the embodiment, the control device 800 transmits the state variable to the server via a network, and receives at least one machine-learned cold isostatic pressing process condition from the server. The at least one cold isostatic pressing process condition is generated by the server that calculates a reward for a result of decision of the at least one cold isostatic pressing process condition based on the state variable, updates, based on the reward, a function to decide the at least one cold isostatic pressing process condition from the state variable while changing the at least one cold isostatic pressing process condition, and decides a cold isostatic pressing process condition which yields a highest reward, by repeating update of the function.

Note that the disclosure can use the following modified embodiments.

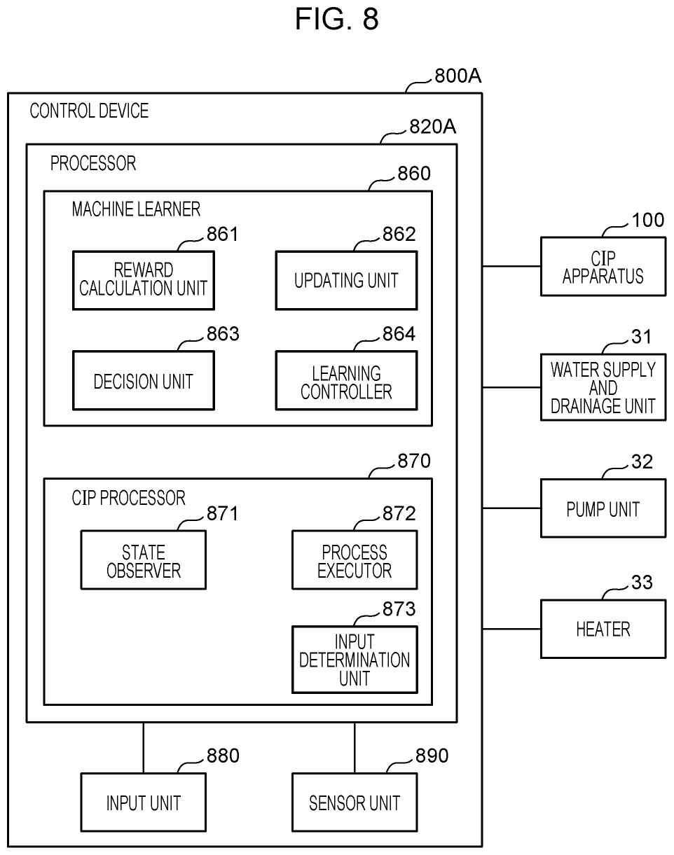

(1) FIG. 8 is an entire configuration diagram of a machine learning system according to a modified embodiment of the disclosure. The machine learning system according to the modified embodiment comprises a control device 800A singly. The control device 800A includes a processor 820A, an input unit 880, and a sensor unit 890. The processor 820A includes a machine learner 860, and a CIP processor 870. The machine learner 860 includes a reward calculation unit 861, an updating unit 862, a decision unit 863, and a learning controller 864. The reward calculation unit 861 to the learning controller 864 are the same as the reward calculation unit 911 to the learning controller 914, respectively illustrated in FIG. 2. The CIP processor 870 includes a state observer 871, a process executor 872, and an input determination unit 873. The state observer 871 to the input determination unit 873 are the same as the state observer 821, the process executor 822, and the input determination unit 823, respectively illustrated in FIG. 2. The input unit 880 and the sensor unit 890 are the same as the input unit 840 and the sensor unit 830, respectively illustrated in FIG. 2. In this modification, the state observer 821 is an example of a state acquisition unit that acquires state information. Note that the sensor unit 890 may be provided inside the control device 800A, or provided outside the control device 800A, and the installation site of the sensor unit 890 is not particularly restricted.

In this manner, with the machine learning system according to the modified embodiment, optimal CIP process conditions can be learned by the control device 800A singly.

(2) In the flow illustrated in FIG. 7, a state variable is observed after the CIP process. However, this is an example, and a state variable may be observed multiple times during a single CIP process. For example, when a state variable is only comprised of parameters which are measurable instantly, multiple state variables can be observed during a single CIP process. Thus, learning time is reduced. When the CIP process is started in step S7 of FIG. 7, the state variable is observed concurrently with evaluation of the physical amount in the process, thereby making it possible to change the CIP process condition during the process so that the physical amount of the object to be processed in the final stage of the CIP process can be made closer to a reference value. In other words, the machine learning method performed by the machine learning system according to the disclosure includes not only a method that decides a cold isostatic pressing process condition which yields a highest reward through multiple CIP processes, but also a method that decides a cold isostatic pressing process condition that yields a highest final reward during a predetermined CIP process.

(3) The communication method according to the disclosure is performed by various processes when the control device 800 illustrated in FIG. 2 communicates with the server 900. The learning program according to the disclosure is implemented by a program that causes a computer to function as the server 900 illustrated in FIG. 2.

What is claimed is:

1. A machine learning method by which a machine learning device decides a cold isostatic pressing process condition for a cold isostatic pressing apparatus that performs a cold isostatic pressing process using a pressure medium for an object to be processed,
the cold isostatic pressing apparatus including:
a pressure vessel that stores the object to be processed,
a compressor that supplies the pressure medium to the pressure vessel,
a pressure adjustment mechanism configured to adjust a pressure in the pressure vessel, and
a control device that controls the cold isostatic pressing apparatus,
the machine learning method comprising:
acquiring a state variable including at least one physical amount related to the object to be processed, and at least one cold isostatic pressing process condition;
calculating a reward for a result of decision of the at least one cold isostatic pressing process condition based on the state variable;
updating, based on the reward, a function to decide the at least one cold isostatic pressing process condition from the state variable while changing the at least one cold isostatic pressing process condition; and
deciding a cold isostatic pressing process condition which yields a highest reward, by repeating update of the function,
wherein the at least one cold isostatic pressing process condition is at least one of a first parameter related to the object to be processed,
a second parameter related to a preceding process of the cold isostatic pressing process, and
a third parameter related to operating conditions of the cold isostatic pressing apparatus,
the at least one physical amount being at least one of a physical amount related to sterilization and inactivation, a physical amount related to shucking, a physical amount related to improvement of taste and flavor, and a physical amount related to improvement of texture and nourishment of the object to be processed.

2. The machine learning method according to claim 1,
wherein the at least one cold isostatic pressing process condition includes the first parameter, and
the first parameter is at least one of an amount of processing, an arrangement, a shape, a dimension, with or without packaging, a true density, a component absorption property of a packaging material and a volume of a packaging material of the object to be processed.

3. The machine learning method according to claim 1,
wherein the at least one cold isostatic pressing process condition includes the second parameter, and
the second parameter is at least one of a preheat temperature, a preheat time, and a degree of vacuum for vacuum packaging.

4. The machine learning method according to claim 1,
wherein the at least one cold isostatic pressing process condition includes the third parameter, and
the third parameter is at least one of a process pressure, a pressure increase rate, a pressure decrease rate, a pressure holding time, with or without stepwise pressure increase, and with or without stepwise pressure decrease in the cold isostatic pressing process.

5. The machine learning method according to claim 1,
wherein the cold isostatic pressing apparatus further includes a temperature adjustment mechanism configured to adjust a temperature of a pressure medium in the pressure vessel, and
the control device is configured to further control the temperature adjustment mechanism.

6. The machine learning method according to claim 4,
wherein the cold isostatic pressing apparatus further includes a temperature adjustment mechanism configured to adjust a temperature of a pressure medium in the pressure vessel,
the control device is configured to further control the temperature adjustment mechanism, and
the third parameter is at least one of a process pressure, a pressure increase rate, a pressure decrease rate, a pressure holding time, with or without stepwise pressure increase, with or without stepwise pressure decrease, a process temperature, a temperature increase rate during process, a temperature decrease rate during process, and a temperature distribution in the cold isostatic pressing process.

7. The machine learning method according to claim 1,
wherein the function is updated using deep reinforcement learning.

8. The machine learning method according to claim 1,
wherein in the calculating the reward, when the at least one physical amount approaches a predetermined reference value corresponding to the physical amount, the reward is increased.

9. A machine learning device that decides a cold isostatic pressing process condition for a cold isostatic pressing apparatus that performs a cold isostatic pressing process using a pressure medium for an object to be processed,
the cold isostatic pressing apparatus including:
a pressure vessel that stores the object to be processed,
a compressor that supplies the pressure medium to the pressure vessel,
a pressure adjustment mechanism configured to adjust a pressure in the pressure vessel, and
a control device that controls the cold isostatic pressing apparatus,
the machine learning device comprising:
a state acquisition unit that acquires a state variable including at least one physical amount related to the object to be processed, and at least one cold isostatic pressing process condition;
a reward calculation unit that calculates a reward for a result of decision of the at least one cold isostatic pressing process condition based on the state variable;
an updating unit that updates, based on the reward, a function to decide the at least one cold isostatic pressing process condition from the state variable while changing the at least one cold isostatic pressing process condition; and
a decision unit that decides a cold isostatic pressing process condition which yields a highest reward, by repeating update of the function,
wherein the at least one cold isostatic pressing process condition is at least one of a first parameter related to the object to be processed,
a second parameter related to a preceding process of the cold isostatic pressing process, and
a third parameter related to operating conditions of the cold isostatic pressing apparatus,
the at least one physical amount being at least one of a physical amount related to sterilization and inactivation, a physical amount related to shucking, a physical amount related to improvement of taste and flavor, and a physical amount related to improvement of texture and nourishment of the object to be processed.

10. A learning program for a machine learning device that decides a cold isostatic pressing process condition for a cold isostatic pressing apparatus that performs a cold isostatic pressing process using a pressure medium for an object to be processed,
the cold isostatic pressing apparatus including:
a pressure vessel that stores the object to be processed,
a compressor that supplies the pressure medium to the pressure vessel,
a pressure adjustment mechanism configured to adjust a pressure in the pressure vessel, and
a control device that controls the cold isostatic pressing apparatus,
the learning program causing a computer to function as:
a state acquisition unit that acquires a state variable including at least one physical amount related to the object to be processed, and at least one cold isostatic pressing process condition;
a reward calculation unit that calculates a reward for a result of decision of the at least one cold isostatic pressing process condition based on the state variable;
an updating unit that updates, based on the reward, a function to decide the at least one cold isostatic pressing process condition from the state variable while changing the at least one cold isostatic pressing process condition; and
a decision unit that decides a cold isostatic pressing process condition which yields a highest reward, by repeating update of the function,
wherein the at least one cold isostatic pressing process condition is at least one of a first parameter related to the object to be processed,
a second parameter related to a preceding process of the cold isostatic pressing process, and
a third parameter related to operating conditions of the cold isostatic pressing apparatus,
the at least one physical amount being at least one of a physical amount related to sterilization and inactivation, a physical amount related to shucking, a physical amount related to improvement of taste and flavor, and a physical amount related to improvement of texture and nourishment of the object to be processed.

11. A communication method of a control device of a cold isostatic pressing apparatus to be trained by machine learning a cold isostatic pressing process condition for the cold isostatic pressing apparatus that performs a cold isostatic pressing process using a pressure medium for an object to be processed,
the cold isostatic pressing apparatus including:
a pressure vessel that stores the object to be processed,
a compressor that supplies the pressure medium to the pressure vessel,
a pressure adjustment mechanism configured to adjust a pressure in the pressure vessel, and
the control device,
wherein the control device observes a state variable including at least one physical amount related to the object to be processed, and at least one cold isostatic pressing process condition,
the control device transmits the variable state to a server via a network, and receives at least one machine-learned cold isostatic pressing process condition from the server,
the at least one cold isostatic pressing process condition is generated by the server that calculates a reward for a result of decision of the at least one cold isostatic pressing process condition based on the state variable, updates, based on the reward, a function to decide the at least one cold isostatic pressing process condition from the state variable while changing the at least one cold isostatic pressing process condition, and decides a cold isostatic pressing process condition which yields a highest reward, by repeating update of the function,
the at least one cold isostatic pressing process condition is at least one of a first parameter related to the object to be processed,
a second parameter related to a preceding process of the cold isostatic pressing process, and
a third parameter related to operating conditions of the cold isostatic pressing apparatus,
the at least one physical amount being at least one of a physical amount related to sterilization and inactivation, a physical amount related to shucking, a physical amount related to improvement of taste and flavor, and a physical amount related to improvement of texture and nourishment of the object to be processed.

12. A control device for a cold isostatic pressing apparatus that performs a cold isostatic pressing process using a pressure medium for an object to be processed,
the cold isostatic pressing apparatus including:
a pressure vessel that stores the object to be processed,
a compressor that supplies the pressure medium to the pressure vessel,
a pressure adjustment mechanism configured to adjust a pressure in the pressure vessel,
a state observer that observes a state variable including at least one physical amount related to the object to be processed, and at least one cold isostatic pressing process condition, and
a communication unit that transmits the variable state to a server via a network, and receives at least one machine-learned cold isostatic pressing process condition from the server,
wherein the at least one cold isostatic pressing process condition is generated by the server that calculates a reward for a result of decision of the at least one cold isostatic pressing process condition based on the state variable, updates, based on the reward, a function to decide the at least one cold isostatic pressing process condition from the state variable while changing the at least one cold isostatic pressing process condition, and decides a cold isostatic pressing process condition which yields a highest reward, by repeating update of the function,
the at least one cold isostatic pressing process condition is at least one of a first parameter related to the object to be processed,
a second parameter related to a preceding process of the cold isostatic pressing process, and
a third parameter related to operating conditions of the cold isostatic pressing apparatus,
the at least one physical amount being at least one of a physical amount related to sterilization and inactivation, a physical amount related to shucking, a physical amount related to improvement of taste and flavor, and a physical amount related to improvement of texture and nourishment of the object to be processed.
